(19) United States
(12) Patent Application Publication
(10) Pub. No.: US 2024/0177706 A1
(43) Pub. Date: May 30, 2024

(54) Monte Carlo Self-Training for Speech Recognition

(71) Applicant: Google LLC, Mountain View, CA (US)

(72) Inventors: Anshuman Tripathi, Mountain View, CA (US); Soheil Khorram, Redwood City, CA (US); Hasim Sak, Santa Clara, CA (US); Han Lu, Redwood, WA (US); Jaeyoung Kim, Cupertino, CA (US); Qian Zhang, Mountain View, CA (US)

(73) Assignee: Google LLC, Mountain View, CA (US)

(21) Appl. No.: 18/515,212

(22) Filed: Nov. 20, 2023

Related U.S. Application Data
(60) Provisional application No. 63/385,532, filed on Nov. 30, 2022.

(51) Int. Cl. G10L 15/06; G10L 15/065; G10L 15/10

(52) U.S. Cl. CPC G10L 15/063; G10L 15/065; G10L 15/10; G10L 2015/0635

(57) ABSTRACT

A method for training a sequence transduction model includes receiving a sequence of unlabeled input features extracted from unlabeled input samples. Using a teacher branch of an unsupervised subnetwork, the method includes processing the sequence of input features to predict probability distributions over possible teacher branch output labels, sampling one or more sequences of teacher branch output labels, and determining a sequence of pseudo output labels based on the one or more sequences of teacher branch output labels. Using a student branch that includes a student encoder of the unsupervised subnetwork, the method includes processing the sequence of input 10 features to predict probability distributions over possible student branch output labels, determining a negative log likelihood term based on the predicted probability distributions over possible student branch output labels and the sequence of pseudo output labels, and updating parameters of the student encoder.

### CROSS REFERENCE TO RELATED APPLICATIONS

This U.S. Patent Application claims priority under 35 U.S.C. § 119(e) to U.S. Provisional Application 63/385,532, filed on Nov. 30, 2022. The disclosure of this prior application is considered part of the disclosure of this application and is hereby incorporated by reference in its entirety.

### TECHNICAL FIELD

This disclosure relates to Monte Carlo self-training for speech recognition.

### BACKGROUND

Automatic speech recognition (ASR) systems attempt to provide accurate transcriptions of what a person has said by taking an audio input and transcribing the audio input into text. In many instances, supervised learning is used to train ASR systems with large quantities of labeled training data that includes audio data and a corresponding transcription. Obtaining the large quantity of labeled training data required to train the ASR systems, however, is often difficult to obtain because of the amount of time, costs, and/or privacy concerns associated with collecting the large labeled training datasets. Training ASR systems using unlabeled training data that includes only audio data can alleviate some of the difficulties with collecting large quantities of labeled training data.

### SUMMARY

One aspect of the disclosure provides a self-training network for training a sequence transduction model. The self-training network includes an unsupervised subnetwork trained on a plurality of unlabeled input samples. The unsupervised subnetwork includes a teacher branch that includes a teacher encoder. The teacher branch is configured to process a sequence of unlabeled input features extracted from the unlabeled input samples to predict probability distributions over possible teacher branch output labels, sample one or more sequences of teacher branch output labels from the predicted probability distributions over possible teacher branch output labels, and determine a sequence of pseudo output labels based on the one or more sequences of teacher branch output labels sampled from the predicted probability distributions over possible teacher branch output labels. The unsupervised subnetwork also includes a student branch that includes a student encoder. The student branch is configured to process the sequence of unlabeled input features extracted from the unlabeled input samples to predict probability distributions over possible student branch output labels, determine a negative log likelihood term based on the predicted probability distributions over possible student branch output labels and the sequence of pseudo output labels, and update parameters of the student encoder based on the negative log likelihood term.

Implementations of the disclosure may include one or more of the following optional features. In some implementations, determining the negative log likelihood term includes determining a negative log of the probability distributions predicted by the student branch for the sequence of pseudo output labels conditioned on the sequence of unlabeled input features. In some examples, each teacher branch output label in each sequence of teacher branch output labels includes a corresponding probability score and the teacher branch determines the sequence of pseudo output labels by determining a combined score based on a sum of the probability scores for the corresponding teacher branch output labels for each corresponding sequence of teacher branch output labels and selecting the sequence of pseudo output labels as the sequence of teacher branch output labels having the highest combined score. The unsupervised subnetwork may be configured to update parameters of the teacher encoder based on an exponential moving average (EMA) of updated parameters of the student encoder. Here, the student encoder and the teacher encoder may be initialized using same parameter weights.

In some implementations, augmentation is applied to the sequence of unlabeled input features processed by the student branch of the unsupervised subnetwork. In these implementations, the augmentation applied may include at least one of frequency-based augmentation or time-based augmentation. No augmentation may be applied to the sequence of unlabeled input features processed by the teacher branch of the unsupervised subnetwork. In some examples, the student encoder includes an encoder neural network having a stack of multi-head attention layers. In these examples, the multi-head attention layers include transformer layers or conformer layers.

In some implementations, the self-training network further includes a supervised subnetwork trained on a sequence of labeled input features paired with a corresponding sequence of ground-truth output labels. The supervised subnetwork includes the student encoder and is configured to process the sequence of labeled input features to predict probability distributions over possible output labels, determine a supervised loss term based on the probability distributions over possible output labels and the sequence of ground-truth output labels, and update parameters of the student encoder based on the supervised loss term. In these implementations, the sequence of labeled input features may include a sequence of labeled acoustic frames characterizing a spoken utterance, the sequence of ground-truth output labels includes a sequence of word or sub-word units characterizing a transcription of the spoken utterance, and the probability distributions over possible output labels include a probability distribution over possible speech recognition results. In some examples, the unlabeled input samples include unlabeled audio samples corresponding to spoken utterances not paired with corresponding transcriptions, the sequence of unlabeled input features includes a sequence of input acoustic frames extracted from the unlabeled audio samples, the probability distributions over possible teacher branch output labels includes probability distributions over possible word or sub-word units, the probability distributions over possible student branch output labels includes probability distributions over possible word or sub-word units, and the sequence of pseudo output labels includes a sequence of pseudo word or sub-word units.

The sequence transduction model may include at least one of a speech recognition model, a character recognition model, or a machine translation model. In some implementations, the sequence transduction model includes a recurrent neural network-transducer (RNN-T) based Transformer-Transducer (T-T) architecture that includes: the student encoder configured to receive a sequence of acoustic frames extracted from audio data characterizing a spoken utterance as input and generate, at each of a plurality of output steps, a higher order feature representation for a corresponding acoustic frame in the sequence of acoustic frames; a label encoder configured to receive a sequence of non-blank symbols output by a final softmax layer as input and generate a dense representation at each of the plurality of output steps; and a joint network configured to receive, as input, the higher order feature representation generated by the student encoder at each of the plurality of output steps and the dense representation generated by the label encoder at each of the plurality of output steps and generate, at each of the plurality of output steps, a probability distribution over possible speech recognition hypotheses at the corresponding output step.

Another aspect of the disclosure provides a computer-implemented method that when executed on data processing hardware causes the data processing hardware to perform operations for training a sequence transduction model. The operations include receiving, as input to a self-training network that includes an unsupervised subnetwork trained on a plurality of unlabeled input samples, a sequence of unlabeled input features extracted from the unlabeled input samples. Using a teacher branch that includes a teacher encoder of the unsupervised subnetwork, the operations include processing the sequence of unlabeled input features to predict probability distributions over possible teacher branch output labels, sampling one or more sequences of teacher branch output labels from the predicted probability distributions over possible teacher branch output labels, and determining a sequence of pseudo output labels based on the one or more sequences of teacher branch output labels sampled from the predicted probability distributions over possible teacher branch output labels. Using a student branch that includes a student encoder of the unsupervised subnetwork, the operations include processing the sequence of unlabeled input features extracted from the unlabeled input samples to predict probability distributions over possible student branch output labels, determining a negative log likelihood term based on the predicted probability distributions over possible student branch output labels and the sequence of pseudo output labels, and updating parameters of the student encoder based on the negative log likelihood term.

Implementations of the disclosure may include one or more of the following optional features. In some implementations, determining the negative log likelihood term includes determining a negative log of the probability distributions predicted by the student branch for the sequence of pseudo output labels conditioned on the sequence of unlabeled input features. In some examples, each teacher branch output label in each sequence of teacher branch output labels includes a corresponding probability score and the teacher branch determines the sequence of pseudo output labels by determining a combined score based on a sum of the probability scores for the corresponding teacher branch output labels for each corresponding sequence of teacher branch output labels and selecting the sequence of pseudo output labels as the sequence of teacher branch output labels having the highest combined score.

The operations may further include updating, using the unsupervised subnetwork, parameters of the teacher encoder based on an exponential moving average (EMA) of updated parameters of the student encoder. Here, the operations further include initializing the student encoder and the teacher encoder using same parameter weights. In some implementations, the operations further include augmenting the sequence of unlabeled input features processed by the student branch of the unsupervised subnetwork. In these implementations, augmenting the sequence of input features processed by the student branch of the unsupervised subnetwork includes at least one of frequency-based augmentation or time-based augmentation. No augmentation may be applied to the sequence of unlabeled input features processed by the teacher branch of the unsupervised subnetwork.

In some examples, the student encoder includes an encoder neural network having a stack of multi-head attention layers. In these examples, the multi-head attention layers include transformer layers or conformer layers. In some implementations, the self-training network further includes a supervised subnetwork trained on a sequence of labeled input features paired with a corresponding sequence of ground-truth labels and includes the student encoder. In these implementations, using the supervised network, the operations include processing the sequence of labeled input features to predict probability distributions over possible output labels, determining a supervised loss term based on the probability distributions over possible output labels and the sequence of ground-truth output labels, and updating parameters of the student encoder based on the supervised loss term. Here, the sequence of labeled input features may include a sequence of labeled acoustic frames characterizing a spoken utterance, the sequence of ground-truth output labels includes a sequence of word or sub-word units characterizing a transcription of the spoken utterance, and the probability distributions over possible output labels includes a probability distribution over possible speech recognition results.

In some examples, the unlabeled input samples include unlabeled audio samples corresponding to spoken utterances not paired with corresponding transcriptions, the sequence of unlabeled input features includes a sequence of input acoustic frames extracted from the unlabeled audio samples, the probability distributions over possible teacher branch output labels includes probability distributions over possible word or sub-word units, the probability distributions over possible student branch output labels includes probability distributions over possible word or sub-word units, and the sequence of pseudo output labels includes a sequence of pseudo word or sub-word units. The sequence transduction model includes at least one of a speech recognition model, a character recognition model, or a machine translation model. In some implementations, the sequence transduction model includes a recurrent neural network-transducer (RNN-T) based Transformer-Transducer (T-T) architecture and the operations further include generating, using the student encoder, at each of a plurality of output steps, a higher order feature representation for a corresponding acoustic frame in a sequence of acoustic frames extracted from audio data characterizing a spoken utterance, generating, using a label encoder, at each of the plurality of output steps, a dense representation based on a sequence of non-blank symbols output by a final softmax layer, and generating, using a joint network, at each of the plurality of output steps, a probability distribution over possible speech recognition hypotheses at the corresponding output step based on the higher order feature representation generated by the student encoder at each of the plurality of output steps and the dense representation generated by the label encoder at each of the plurality of output steps.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIG. 2 is a schematic view of an example sequence transduction model.

FIG. 3A is a schematic view of a supervised part of a self-training network for training the sequence transduction model.

FIG. 3B is a schematic view of an unsupervised part of a self-training network for training the sequence transduction model.

FIG. 4 is an illustration of an example sampling algorithm used by the unsupervised part of FIG. 3B.

FIG. 5 is a flowchart of an example arrangement of operations for a computer-implemented method of a self-training network for training the sequence transduction model.

FIG. 6 is a schematic view of an example computing device that may be used to implement the systems and methods described herein.

Like reference symbols in the various drawings indicate like elements.

### DETAILED DESCRIPTION

Automatic speech recognition (ASR) systems have made significant improvements in speech recognition errors by utilizing unsupervised speech data during training. One approach of utilizing the unsupervised speech training data includes using a trained teacher model to perform knowledge transfer (i.e., knowledge distillation) to a student model that is not trained (or only partially trained) on a particular task the teacher model is trained to perform. In particular, this teacher-student training approach includes using the teacher model to generate pseudo-labels from unsupervised speech training data and training a student model using the generated pseudo-labels in a semi-supervised manner. However, the teacher-student training approach introduces a confirmation bias between the student and teacher models. That is, errors, such as recognition errors, generated by the teacher model are propagated to the student model which will then make similar errors. The confirmation bias problem introduces further issues when a student model aims to match alignments of a teacher model when the models have different architectures. For example, when the student model operates in a streaming fashion and the teacher model operates in a non-streaming fashion.

Accordingly, implementations herein are directed towards a self-training network for training a sequence transduction model. As will become apparent, the sequence transduction model may include a speech recognition model, a character recognition model, or a machine translation model. The self-training network includes an unsupervised subnetwork trained on a plurality of unlabeled input samples and has a teacher branch having a teacher encoder and a student branch having a student encoder. The teacher branch processes a sequence of unlabeled input features to predict probability distributions over possible teacher branch output labels. Thereafter, the teacher branch samples one or more sequences of teacher branch output labels from the predicted probability distributions over possible teacher branch output labels and determines a sequence of pseudo output labels based on the sampled one or more sequences of teacher branch output labels.

Notably, the sampled one or more sequences of teacher branch output labels may be randomly sampled from the probability distribution such that the sampled one or more sequences of teacher output labels does not always include the teacher branch output labels having the highest probability value. Instead, the pseudo output labels output by the teacher branch correspond to the teacher branch output labels having the highest probability value from the sampled one or more sequences of teacher branch output labels instead of the highest probability distribution from the entire probability distribution. Advantageously, by first sampling the one or more sequences of teacher branch output labels from the probability distribution and then selecting the sampled sequence of teacher branch output labels having the highest probability value, the self-training network avoids the confirmation bias problem of using inaccurate pseudo labels generated by the teacher encoder even though the inaccurate pseudo labels may have high probability values. Simply put, by randomly sampling the one or more sequences of teacher branch output labels, the self-training network filters out pseudo output labels (e.g., ground-truth labels) that may be inaccurate, and thus, prevents propagating inaccuracies from the teacher encoder to the student encoder. In contrast, conventional approaches may simply use the pseudo labels having the highest probability values to train the student encoder (e.g., without first sampling the probability distribution) which can result in training the student encoder with inaccurate pseudo labels that have high probability values.

The student branch processes the sequence of unlabeled input features to predict probability distributions over possible student branch output labels, determines a negative log likelihood term based on the predicted probability distributions over possible student branch output labels and the sequence of pseudo output labels, and updates parameters of the student encoder based on the negative log likelihood term. As will become apparent, in some examples, the student branch only processes unlabeled input features that the teacher branch generated pseudo output labels for and discards unlabeled input features for which the teacher branch did not generate any corresponding pseudo output labels. Thus, the teacher branch filters which unlabeled input samples the student branch uses to train the student encoder. Put another way, the teacher branch controls knowledge distillation from the teacher encoder to the student encoder through generating pseudo output labels. In this manner, the self-training network ensures that the knowledge distillation from the teacher encoder to the student encoder prevents error propagation or confirmation bias. Moreover, the self-training network may update parameters of the teacher encoder based on an exponential moving average (EMA) of updated parameters of the student encoder such that the teacher encoder generates more accurate outputs as the student encoder receives knowledge distillation from the teacher encoder.

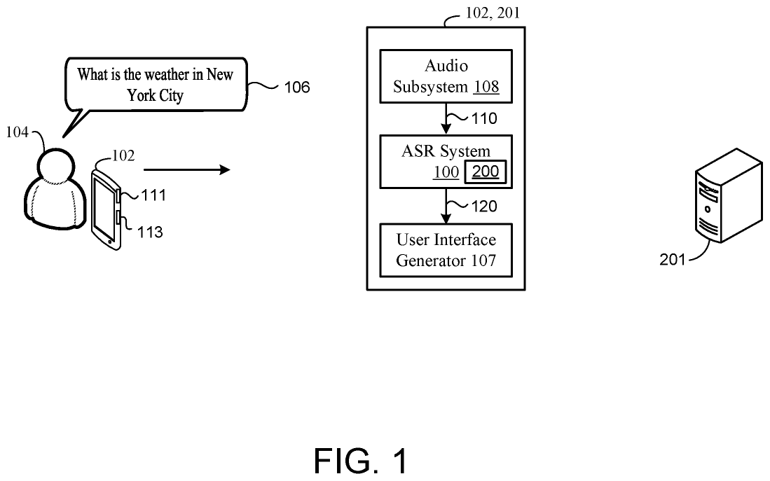

FIG. 1 illustrates an automated speech recognition (ASR) system 100 implementing a sequence transduction model 200 that resides on a user device 102 of a user 104 and/or on a remote computing device 201 (e.g., one or more servers of a distributed system executing in a cloud-computing environment) in communication with the user device 102. In the example shown, the sequence transduction model 200 includes an ASR model that transcribes text from speech inputs. As such, the sequence transduction model 200 and ASR model 200 may be used interchangeably herein. In other examples, however, the sequence transduction model 200 may include models for other tasks, such as a character recognition model that recognizes character representations from textual inputs and/or a machine translation model that translates textual inputs in a particular language into one or more different languages. Although the user device 102 is depicted as a mobile computing device (e.g., a smart phone), the user device 102 may correspond to any type of computing device such as, without limitation, a tablet device, a laptop/desktop computer, a wearable device, a digital assistant device, a smart/speaker display, a smart appliance, an automotive infotainment system, or an Internet-of-Things (IoT) device, and is equipped with data processing hardware 111 and memory hardware 113.

The user device 102 includes an audio subsystem 108 configured to receive an utterance spoken by the user 104 (e.g., the user device 102 may include one or more microphones for recording the spoken utterance 106) and convert the utterance 106 into a corresponding digital format associated with input acoustic frames (i.e., audio features) 110 capable of being processed by the ASR system 100. In the example shown, the user 104 speaks a respective utterance 106 in a natural language of English for the phrase “What is the weather in New York City?” and the audio subsystem 108 converts the utterance 106 into corresponding acoustic frames 110 for input to the ASR system 100. Thereafter, the ASR model 200 receives, as input, the acoustic frames 110 corresponding to the utterance 106, and generates/predicts, as output, a corresponding transcription 120 (e.g., recognition result/hypothesis) of the utterance 106. In the example shown, the user device 102 and/or the remote computing device 201 also executes a user interface generator 107 configured to present a representation of the transcription 120 of the utterance 106 to the user 104 of the user device 102. In some configurations, the transcription 120 output from the ASR system 100 is processed, e.g., by a natural language understanding (NLU) module executing on the user device 102 or the remote computing device 201, to execute a user command. Additionally or alternatively, a text-to-speech system (e.g., executing on any combination of the user device 102 or the remote computing device 201) may convert the transcription 120 into synthesized speech for audible output by another device. For instance, the original utterance 106 may correspond to a message the user 104 is sending to a friend in which the transcription 120 is converted to synthesized speech for audible output to the friend to listen to the message conveyed in the original utterance 106.

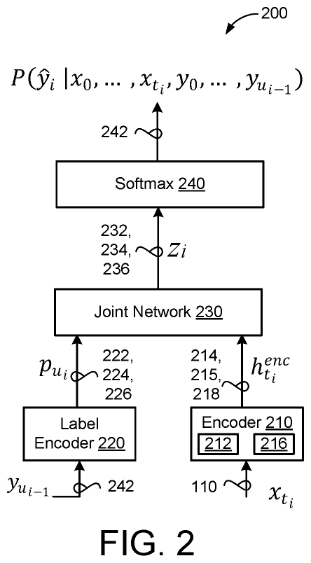

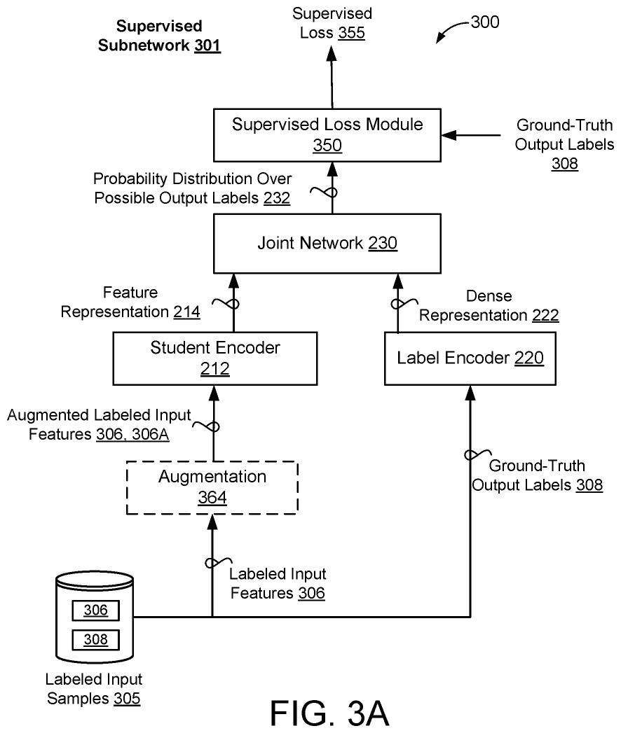

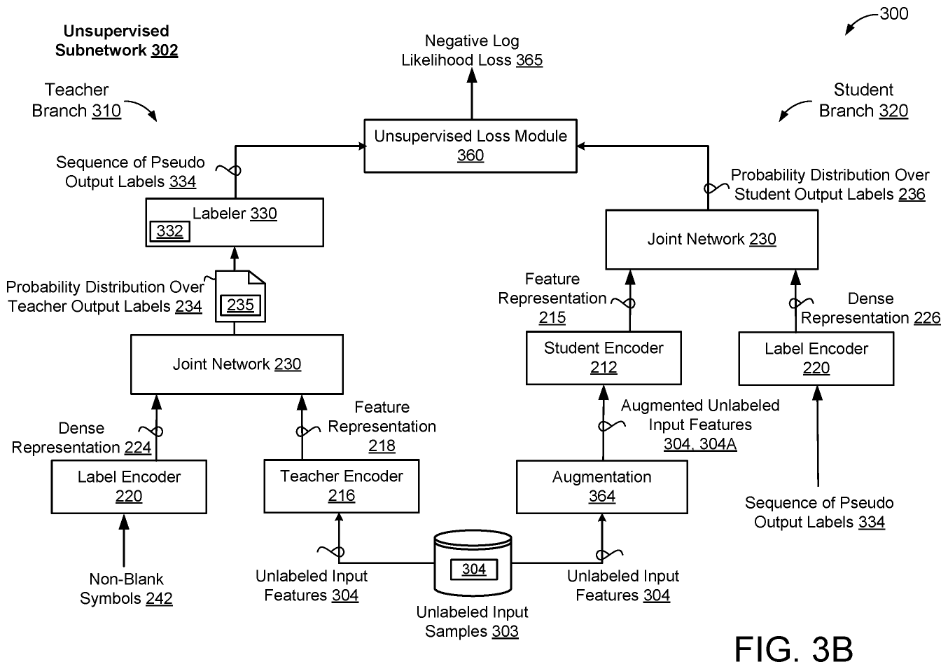

FIG. 2 shows an example sequence transduction model 200. For instance, the sequence transduction model 200 may provide an end-to-end (E2E) speech recognition model by integrating acoustic, pronunciation, and language models into a single neural network, and does not require a lexicon or separate text normalization component. Various structures and optimization mechanisms can provide increased accuracy and reduced model training time. In some implementations, the sequence transduction model 200 includes a Recurrent Neural Network-Transducer (RNN-T) based Transformer-Transducer (T-T) model architecture, which adheres to latency constraints associated with interactive applications. The T-T model architecture may include the T-T model architecture described in U.S. patent application Ser. No. 17/210,465, filed on Mar. 23, 2021, the contents of which are incorporated herein by reference in their entirety. The T-T model architecture provides a small computational footprint and utilizes less memory requirements than conventional ASR architectures, making the T-T model architecture suitable for performing speech recognition entirely on the user device 102 (e.g., no communication with the remote computing device 201 (FIG. 1) is required). The T-T model architecture of the sequence transduction model 200 may include an encoder 210, a label encoder 220, and joint network 230. The encoder 210, which is roughly analogous to an acoustic model (AM) in a traditional ASR system, may include a neural network having a stack of strided convolutional layers and transformer layers. Moreover, the encoder 210 may include a student encoder 212 (FIGS. 3A and 3B) and a teacher encoder 216 (FIG. 3B). The encoder 210 reads a sequence of d-dimensional feature vectors (e.g., acoustic frames 110) x=(x₁, x₂, . . . , x_{T}), where xₜ∈ [symbol] _{d}, and produces, at each of a plurality of output steps, a higher order feature representation 214, 215, 218. This higher order feature representation is denoted as h₁^{enc}, . . . , h_{T}^{enc}.

Each transformer layer of the encoder 210 may include a normalization layer, a masked multi-head attention layer with relative position encoding, residual connections, a stacking/unstacking layer, and a feedforward layer. Similarly, the label encoder 220 may also include a neural network of transformer layers or a look-up table embedding model, which, like a language model (LM), processes a sequence of non-blank symbols 242 output by a final Softmax layer 240 so far, y₀, . . . , yᵤᵢ₋₁, into a dense representation 222, 224, 226 (pᵤ_{ᵢ}) that encodes predicted label history. In implementation when the label encoder 220 includes the neural network of transformer layers, each transformer layer may include a normalization layer, a masked multi-head attention layer with relative position encoding, a residual connection, a feedforward layer, and a dropout layer. In these implementations, the label encoder 220 may include two transformer layers. In implementations when the label encoder 220 includes the look-up table embedding model with a bi-gram label context, the embedding model is configured to learn a weight vector of the d-dimension for each possible bigram label context, where d is the dimension of the outputs of the encoder 210 and the label encoder 220. In some examples, the total number of parameters in the embedding model is N²×d where N is the vocabulary size for the labels. Here, the learned weight vector is then used as the embedding of the bigram label context in the T-T model architecture to produce fast label encoder 220 runtimes.

Finally, with the T-T model architecture, the representations produced by the encoders 210, 220 are combined by the joint network 230 using a dense layer J_{u,t}. The joint network 230 then predicts P(yᵢ|xₜ_{ᵢ}, y₀, . . . , yᵤ_{ᵢ₋₁}), which is a probability distribution over the next output symbol 232, 234, 236. Stated differently, the joint network 230 may generate, at each output step (e.g., time step), a probability distribution over possible speech recognition hypotheses. Here, the “possible speech recognition hypotheses” correspond to a set of output labels (also referred to as “speech units”) each representing a grapheme (e.g., symbol/character) or a word piece in a specified natural language. For example, when the natural language is English, the set of output labels may include twenty-seven (27) symbols, e.g., one for each of the 26-letters in the English alphabet and one label designating a space. Accordingly, the joint network 230 may output a set of values indicative of the likelihood of occurrence of each of a predetermined set of output labels. This set of values can be a vector (e.g., a one-hot vector) and can indicate a probability distribution over the set of output labels. In some cases, the output labels are graphemes (e.g., individual characters, and potentially punctuation and other symbols), but the set of output labels is not so limited. For example, the set of output labels can include wordpieces and/or entire words, in addition to or instead of graphemes. The output distribution of the joint network 230 can include a posterior probability value for each of the different output labels. Thus, if there are 100 different output labels representing different graphemes or other symbols, the output zᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the ASR model 200 at the corresponding output step. In this manner, the sequence transduction model 200 does not make a conditional independence assumption, rather the prediction of each symbol is conditioned not only on the acoustics but also on the sequence of labels output so far. While the sequence transduction model 200 is described as having the T-T model architecture, the sequence transduction model 200 may include other types of transducer-based architectures, such as a Conformer-Transducer (C-T) mode architecture or a Recurrent Neural Network-Transducer (RNN-T) architecture.

FIGS. 3A and 3B illustrate schematic views of a self-training network 300 executing a semi-supervised training process for training the sequence transduction model 200 (FIG. 2). The self-training network 300 includes a supervised subnetwork training process 301 (FIG. 3A) and an unsupervised subnetwork training process 302 (FIG. 3B). The supervised subnetwork training process (i.e., supervised subnetwork) 301 trains the sequence transduction model 200 using a sequence of labeled input samples 305 paired with a corresponding sequence of ground-truth output labels 308. Each labeled input sample 305 includes a sequence of labeled input features 306 extracted from the respective labeled input sample 305. The unsupervised subnetwork training process (i.e., unsupervised subnetwork) 302 trains the sequence transduction model 200 using a plurality of unlabeled input samples 303. Each unlabeled input sample 303 includes a sequence of unlabeled input features 304 extracted from the unlabeled input sample 303 and is not paired with any corresponding ground-truth label. In some examples, the sequence of input features 304, 306 includes a sequence of acoustic frames characterizing a spoken utterance. In these examples, the sequence transduction model 200 includes an ASR model that is trained on the acoustic frames to learn how to recognize speech. In other examples, the sequence of input features 304, 306 includes a sequence of text units (e.g., written characters or text in a particular language) characterizing a textual input for character recognition and/or machine translation. In these other examples, the sequence transduction model 200 includes a character recognition model that is trained on the text units to learn to recognize characters from textual input and/or includes a machine translation model that is trained on the labeled text units to learn to translate the textual input into text in one or more different languages.

In some examples, the labeled input features 306 used by the supervised subnetwork (i.e., supervised part) 301 are the same as the unlabeled input features 304 used by the unsupervised subnetwork (i.e., unsupervised part) 302. That is, the supervised part 301 and the unsupervised part 302 may train the sequence transduction model 200 using the same input features 304, 306 concurrently while the unlabeled input features 304 used by the unsupervised part 302 remain unpaired from any ground-truth labels. In other examples, the labeled input features 306 used to train the supervised part 301 are different from the unlabeled input features 304 used to train the unsupervised part 302. This scenario is especially beneficial since the unlabeled input samples 303 without any paired ground-truth labels are easy to obtain and can be leveraged to train the sequence transduction model 200. As such, the sequence transduction model 200 may be trained on any combination of labeled input samples 305 and/or unlabeled input samples 303. In some examples, the sequence of input features 304, 306 extracted from the unlabeled input samples 303 and the labeled input samples 305 include log Mel-filterbank energies. A greater number of unlabeled input samples 303 may be used to train the unsupervised part 302 than the number of labeled input samples 305 used to train the supervised part 301. Optionally, a greater number of labeled input samples 305 may be used to train the supervised part 301 than the number of unlabeled input samples 303 used to train the unsupervised part 302. In some examples, the number of labeled input samples 305 used to train the supervised part 301 and the number of unlabeled input samples 303 used to train the unsupervised part 302 are the same.

The unsupervised part 302 includes a teacher branch 310 that includes the teacher encoder 216 of the sequence transduction model 200 (FIG. 2). The unsupervised part 302 also includes student branch 320 having the student encoder 212 of the sequence transduction model 200 that is shared with the supervised part 301. Here, the teacher encoder 216 is different than the student encoder 212. In particular, the teacher encoder 216 may be a trained encoder such that the self-training network 300 distills knowledge (i.e., knowledge transfer) learned by the teacher encoder 216 to the student encoder 212 for particular speech-related tasks such as speech recognition, character recognition, and/or machine translation.

The teacher encoder 216 and the student encoder 212 may each include an encoder neural network having a stack of multi-head self-attention layers. For instance, the multi-head self-attention layers may include transformer layers or conformer layers. In other instances, the teacher encoder 216 and the student encoder 212 each include a stack of strided convolutional layers (e.g., two convolutional layers) and transformer layers (e.g., twenty (20) bidirectional transformer layers). In some implementations, the teacher encoder 216 and the student encoder 212 each include a respective non-causal encoder operating in a non-streaming fashion. In other implementations, the teacher encoder 216 and the student encoder 212 each include a respective causal encoder operating in a streaming fashion. In yet other implementations, the teacher encoder 216 and the student encoder 212 each include respective cascaded encoders such that the encoders operate in both the non-streaming and streaming fashion. As will become apparent, training the sequence transduction model 200 may include updating parameters of the student encoder 212 and/or the teacher encoder 216 based on any combination of losses derived from the self-training network 300.

Referring now to FIG. 3A, the supervised part 301 of the self-training network 300 trains the sequence transduction model 200 using the sequence of labeled input features 306 extracted from the labeled input samples 305. The sequence of labeled input features 306 are paired with a corresponding sequence of ground-truth output labels 308. In some examples, the sequence of labeled input features 306 includes a sequence of labeled acoustic frames characterizing a spoken utterance and the sequence of ground-truth output labels 308 includes a sequence of word or sub-word units characterizing a transcription of the spoken utterance. The supervised part 301 shares the same student encoder 212 from the ASR model 200 as the student branch 320 of the unsupervised part 302. The supervised part 301 also includes the label encoder 220 and the joint network 230 of the ASR model 200 (FIG. 2).

Optionally, the supervised part 301 may include a data augmentation module 364 (e.g., denoted by the dashed lines) that applies data augmentation to the sequence of labeled input features 306 to generate a sequence of augmented labeled input features 306, 306A. The data augmentation module 364 of the supervised part 301 may be the same (or different) as the data augmentation module 364 of the unsupervised part 302 (FIG. 3B) that applies data augmentation to the sequence of unlabeled input features 304. The data augmentation module 364 of the supervised part 301 may apply the same or different data augmentation techniques than the data augmentation module 364 of the unsupervised part 302. Applying data augmentation to the sequence of input features 304, 306 furthers the diversity of training samples used to train the sequence transduction model 200. The data augmentation module 364 may include a time masking component (i.e., time-based augmentation) that masks portions of the input features and/or a frequency masking component (i.e., frequency-based augmentation) that masks portions of the input features. Other techniques applied by the data augmentation module 364 may include adding/injecting noise and or/ adding reverberation to the sequence of input features 304, 306. One data augmentation technique includes using multistyle training (MTR) to inject a variety of environmental noises to the sequence of input features 304, 306. Another augmentation technique that the data augmentation module 364 may apply in addition to, or in lieu of, MTR includes using spectrum augmentation (SpecAugment) to increase diversity of the sequence of input features 304, 306. In combination, MTR and SpecAugment may inject noises into the sequence of input features 304, 306, tile random external noise sources along time and inserted before and overlapped onto the representation, and filtering the noise-injective sequence of input features 304, 306 prior to training the sequence transduction model 200.

In some examples, when the supervised part 301 includes the data augmentation module 364, the student encoder 212 receives the augmented sequence of labeled input features 306A and generates, at each output step, a higher order feature representation 214 for a corresponding augmented labeled input feature 306A. In other examples, when the supervised part 301 does not include the data augmentation module 364, the student encoder 212 receives the sequence of labeled input features 306 directly (not shown) and generates, at each output step, the higher order feature representation 214 for a corresponding labeled input feature 306. More specifically, the student encoder 212 may include strided convolutional layers that receive the augmented labeled input feature 306A (or labeled input feature 306) and generate a corresponding output. Here, the student encoder 212 may include transformer layers that receive the corresponding output from the strided convolutional layers and generate the higher order feature representation 214 based on the corresponding output.

In some examples, the label encoder 220 is a streaming transformer that does not attend to future inputs. Accordingly, the label encoder 220 receives the sequence of ground-truth output labels 308 that corresponds to the sequence of labeled input features 306 received by the student encoder 212 and generates, at each output step, a linguistic embedding 222 (i.e., dense representation pᵤ_{ᵢ} (FIG. 2)) for a corresponding ground-truth output label 308 from the sequence of ground-truth output labels 308. The supervised part 301 includes the joint network 230 that processes the dense representation 222 generated by the label encoder 220 at each output step and the higher order feature representation 214 generated by the student encoder 216 at each output step to generate, at each output step, a corresponding probability distribution over possible output labels 232 for a corresponding augmented labeled input feature 306A (or labeled input feature 306). The joint network 230 may include dense layers having a trainable bias vector that performs a linear operation on the higher order feature representation 214 and the dense representation 222 to generate the probability distribution over possible output labels 232. When the sequence of labeled input features 306 includes the sequence of labeled acoustic frames characterizing the spoken utterance, the probability distribution over possible output labels 232 includes a probability distribution over possible speech recognition results. In other scenarios, when the sequence of labeled input features 306 includes a sequence of labeled text units characterizing a written character or text in a particular language, the probability distribution over possible output labels 232 includes a probability distribution over possible character recognition results or text units in one or more different languages.

A supervised loss module 350 of the supervised part 301 determines, at each of the plurality of output steps, a supervised loss term 355 based on the probability distributions 232 over possible output labels generated by the joint network 230 and the corresponding sequence of ground-truth output labels 308. That is, the supervised loss module 350 compares the probability distribution 232 over possible output labels to the corresponding sequence of ground-truth output labels 308 to determine the supervised loss term 355. Thus, the supervised loss module 350 determines the supervised loss term 355 according to:

rₜ=linear(tan h(linear(aₜ)+linear(lₜ))) (1)

In Equation 1, rₜ represents a logit vector that specifies the probability graphemes including the blank symbol, aₜ represents the higher order feature representation 214 generated by the student encoder 212, lₜ represents the dense representation 222 generated by the label encoder 220, and linear represents the conventional dense layers with the trainable bias vector of the joint network 230.

The supervised part 301 updates parameters of the sequence transduction model 200 based on the supervised loss term 355 determined at each of the plurality of output steps for each labeled input sample 305. In some implementations, the supervised part 301 is configured to update the parameters of the sequence transduction model 200 based on the supervised loss term 355 independently of the unsupervised part 302 updating the parameters of the sequence transduction model 200. In other implementations, the supervised part 301 is configured to update the parameters of the sequence transduction model 200 based on the supervised loss term 355 jointly with the unsupervised part 302 updating the parameters of the sequence transduction model 200. Updating parameters of the sequence transduction model 200 may include updating parameters of the student encoder 212.

Referring now to FIG. 3B, the unsupervised part 302 trains the sequence transduction model 200 using the plurality of unlabeled input samples 303. Each unlabeled input sample 303 includes a sequence of unlabeled input features 304 extracted from the respective unlabeled input sample 303 and is not paired with any ground-truth output labels. In some implementations, the unlabeled input samples 303 include unlabeled audio samples corresponding to spoken utterances not paired with corresponding transcriptions (i.e., ground-truth labels) and the sequence of unlabeled input features 304 includes a sequence of input acoustic frames extracted from the unlabeled audio samples. The unsupervised part 302 of the self-training network 300 includes a teacher branch 310 and a student branch 320. The teacher branch 310 of the unsupervised part 302 may include the teacher encoder 216, the label encoder 220, the joint network 230, and a labeler 330. On the other hand, the student branch 320 of the unsupervised part 302 may include the data augmentation module 364, the student encoder 212, the label encoder 220, and the joint network 230. Here, the student branch 320 shares the same student encoder 212 of the ASR model 200 as the supervised part 301 (FIG. 3A). The label encoder 220 and the joint network 230 of the student branch 320 and the teacher branch 310 may include the same (or different) respective label encoders 220 and joint networks 230. As will become apparent, the unsupervised part 302 is configured to teach the student encoder 212 to generate higher order feature representations 214 that match higher order feature representations 218 generated by the teacher encoder 216 for the same corresponding unlabeled input features 304.

In particular, the teacher encoder 216 of the teacher branch 310 is configured to generate a higher order feature representation 218 for a corresponding unlabeled input feature 304 in the sequence of unlabeled input features 304. Notably, the unsupervised part 302 applies no augmentation to the sequence of unlabeled input features 304 processed by the teacher branch 310. In contrast, the unsupervised part 302 applies augmentation to the sequence of unlabeled input features 304 processed by the student branch 320. In some examples, the label encoder 220 of the teacher branch 310 is a streaming transformer that does not attend to future inputs. Accordingly, the label encoder 220 of the teacher branch 310 is configured to receive, as input, a sequence of non-blank symbols 242 output by the final softmax layer 240 (FIG. 2) at each output step and generate, at each output step, a dense representation 224 for a corresponding non-blank symbol 242 from the sequence of non-blank symbols 242. That is, the final softmax layer 240 may perform beam searching on a probability distribution 234 output by the joint network 230 of the teacher branch 310 whereby the label encoder 220 receives the non-blank symbols 242 selected by the final softmax layer 240 during beam searching. Simply put, the non-blank symbols 242 received by the label encoder 220 represent non-blank output labels generated by the joint network 230 at previous output steps.

The teacher branch 310 also includes the joint network 230 that processes the dense representation 224 generated by the label encoder 220 at each output step and the higher order feature representation 218 generated by the teacher encoder 216 at each output step and generates, at each output step, a corresponding probability distribution over possible teacher branch output labels 234 for a corresponding unlabeled input feature 304 in the sequence of unlabeled input features 304. When the unlabeled input samples 303 include unlabeled audio samples corresponding to spoken utterances not paired with corresponding transcriptions, the probability distributions over possible teacher branch output labels 234 includes probability distributions over possible word or sub-word units. In other scenarios, when the sequence of unlabeled input features 304 includes a sequence of unlabeled text units characterizing a written character or text in a particular language, the probability distribution over possible teacher branch output labels 234 includes a probability distribution over possible character recognition results or text units in one or more different languages.

Thereafter, the labeler 330 is configured to determine a sequence of pseudo output labels 334 based on the probability distribution over possible teacher branch output labels 234 generated by the joint network 230 of the teacher branch 310 at each output step. The probability distribution may include N number of possible teacher branch output labels. The labeler 330 samples one or more sequences of teacher branch output labels 332 from the predicted probability distributions over possible teacher branch output labels 234 and determines the sequence of pseudo output labels 334 based on the one or more sequences of teacher branch output labels 332 sampled from the predicted probability distributions over possible teacher branch output labels 234. The sequence of pseudo output labels 334 output by the labeler 330 serve as semi-supervised ground-truth labels for knowledge distillation from the teacher encoder 216 to the student encoder 212. That is, the student branch 320 assumes the pseudo output labels 334 determined by the labeler 330 are accurate such that the pseudo output labels 334 serve as ground-truth labels for training the student encoder 212.

The labeler 330 may sample Nₛ number of sequences of teacher branch output labels from the predicted probability distribution over possible teacher branch output labels 234. For example, the probability distribution over possible teacher branch output labels 234 may include five (5) possible sequences of teacher branch output labels 332 whereby the labeler 330 samples three (3) of the five (5) sequences of possible teacher branch output labels as the sampled sequences of teacher branch output labels 332 (e.g., Nₛ equal to three (3)). The sampling of the one or more sequences of teacher branch output labels 332 may be a random sampling, however, any suitable sampling technique can be employed. As such, in some instances, the sequence of teacher branch output labels 332 sampled from the probability distribution does not include the sequence of teacher branch output labels 332 having the highest confidence value from the probability distribution. In other instances, the sequence of teacher branch output labels 332 sampled from the probability distribution does include the sequence of teacher branch output labels 332 having the highest confidence value from the probability distribution.

Advantageously, by sampling one or more sequences of teacher branch output labels 332 from the predicted probability distributions over possible teacher branch output labels 234, the self-training network 300 does not use all of the unlabeled input samples 303 to train the student encoder 212. Instead, the self-training network 300 may only train the student encoder 212 using only unlabeled input samples 303 from which the labeler 330 generates corresponding sequence of pseudo output labels 334 (e.g., from which the labeler 330 samples). Stated differently, when the labeler 330 does not output a corresponding sequence of pseudo output labels 334 for a respective unlabeled input feature 304, the student branch 320 does not use the respective unlabeled input feature 304 to train the student encoder 212. By sampling the one or more sequences of teacher branch output labels 332 from the predicted probability distributions over possible teacher branch output labels 234, the self-training network 300 may filter inaccurate pseudo output labels generated by the teacher branch even though the inaccurate pseudo output labels may have high (or even the highest) probability values.

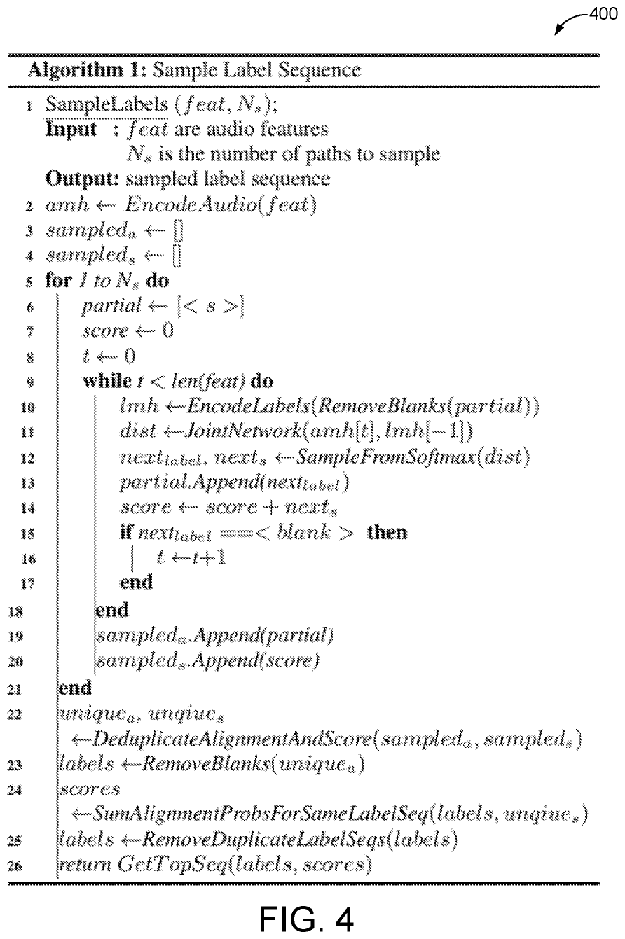

FIG. 4, illustrates pseudo code of an example sampling process 400 executed by the labeler 330 (FIG. 3B). Notably, lines 4-21 of the example sampling process 400 represent sampling Nₛ alignments from the probability distribution output by the joint network 230 of the teacher branch 310. On other hand, lines 21-26 illustrate combining scores of alignments corresponding to same label sequences and outputting the sequence of pseudo output labels 334 as the label sequence having the highest score. As such, when Nₛ is equal to one (1), the score combination step is not required because the single sampled label sequence is output as the pseudo output label 334. Alternatively, when Nₛ is greater than one (1), the labeler 330 selects the label sequence having the highest score as the sequence of pseudo output labels 334.

To that end, in some examples, each teacher branch output label in each sequence of teacher branch output labels from the probability distribution 234 includes a corresponding probability score 235 indicating an accuracy of the respective teacher branch output label. Thus, in these examples, the labeler 330 determines the sequence of pseudo output labels 334 by determining a combined score based on a sum of the probability scores 235 for the corresponding teacher branch output labels and selects the sequence of pseudo output labels 334 as the sequence of teacher branch output labels having the highest combined score. Simply put, the labeler 330 selects the sequence of pseudo output labels 334 as the teacher branch output labels having the highest probability score 235 from the one or more sequences of teacher branch output labels 332 sampled from the probability distribution. In contrast, other implementations may simply select the pseudo output labels 334 as the teacher branch output labels having the highest probability score 235 without first sampling/filtering teacher branch output labels from the probability distribution. When the unlabeled input samples 303 include unlabeled audio samples corresponding to spoken utterances not paired with corresponding transcriptions, the sequence of pseudo output labels 334 includes a sequence of pseudo word or sub-word units. In other scenarios, when the sequence of unlabeled input features 304 includes a sequence of labeled text units characterizing a written character or text in a particular language, the sequence of pseudo output labels 334 includes a sequence of pseudo character recognition results or text units in one or more different languages. The labeler 330 outputs the sequence of pseudo output labels 334 to the label encoder 220 of the student branch 320 and the unsupervised loss module 360 of the unsupervised part 302. In some implementations, the labeler 330 applies a stop gradient operation on the sequence of pseudo output labels 334 output from the labeler 330 to prevent back-propagation of gradients (i.e., losses) to the teacher encoder 216 through the teacher branch 310.

In contrast to the teacher branch 310 of the unsupervised part 302, the student branch 320 of the unsupervised part 302 applies augmentation to the sequence of unlabeled input features 304 extracted from the unlabeled input samples 303 using the data augmentation module 364, as described above. As such, the student branch 320 processes augmented unlabeled input features 304, 304A in contrast to the non-augmented unlabeled input features 304 processed by the target branch. Notably, the student branch 320 may only process augmented unlabeled input features 304A for unlabeled input features 304 that the teacher branch 310 generated a corresponding sequence of pseudo output labels 334 based on. In short, by only processing augmented unlabeled input features 304A that the teacher branch 310 output a corresponding sequence of pseudo output labels 334 for, the teacher branch 310 filters which unlabeled input samples 303 that the self-training network 300 uses to train the student encoder 212.

The student encoder 212 of the student branch 320 receives the augmented sequence of unlabeled input features 304A and generates, at each output step, a higher order feature representation 215 for a corresponding augmented unlabeled input feature 304A. The student encoder 212 may include strided convolutional layers that receive the augmented unlabeled input feature 304A and generate a corresponding output. Here, the student encoder 212 may include transformer layers that receive the corresponding output from the strided convolutional layers and generate the higher order feature representation 215 based on the corresponding output. The label encoder 220 of the student branch 320 is configured to receive, as input, the sequence of pseudo output labels 334 output by the labeler 330 of the teacher branch 310 at each output step and generate, at each output step, a dense representation 226 for a corresponding pseudo output label 334 from the sequence of pseudo output labels 334.

The student branch 320 also includes the joint network 230 that processes the dense representation 226 generated by the label encoder 220 at each output step and the higher order feature representation 215 generated by the student encoder 212 at each output step and generates, at each output step, a corresponding probability distribution over possible student branch output labels 236 for a corresponding augmented unlabeled input feature 304A in the sequence of augmented unlabeled input features 304A. When the unlabeled input samples 303 include unlabeled audio samples corresponding to spoken utterances not paired with corresponding transcriptions, the probability distributions over possible student branch output labels 236 include probability distributions over possible word or sub-word units. In other scenarios, when the sequence of unlabeled input features 304 includes a sequence of unlabeled text units characterizing a written character or text in a particular language, the probability distributions over possible student branch output labels 236 include a probability distribution over possible character recognition results or text units in one or more different languages

An unsupervised loss module 360 of the unsupervised part 302 determines, at each of the plurality of output steps, a negative log likelihood loss term 365 based on the probability distributions over possible student branch output labels 236 generated by the joint network 230 of the student branch 320 and the corresponding sequence of pseudo output labels 334 generated by the labeler 330 of the teacher branch 310. That is, the unsupervised loss module 360 determines a negative log of the probability distribution over possible student branch output labels 236 predicted by the student branch 320 for the sequence of pseudo output labels 334 conditioned on the sequence of unlabeled input features 304. In short, the unsupervised loss module 360 compares the negative log of the probability distributions over possible student branch output labels 236 to the corresponding sequence of pseudo output labels 334 to determine the negative log likelihood loss term 365. As such, the self-training network 300 aims to teach the student encoder 212 to generate similar higher order feature representations 215 as the higher order feature representations 218 generated by the teacher encoder 216 for the same corresponding unlabeled input features 304. Thus, the unsupervised loss module 360 determines the negative log likelihood loss term 365 according to:

$$L o s {s}_{C E} ( x ) = {\sum }_{∀ y} - {P}_{{θ}_{T}} ( y \vert x ) \times ln ( {P}_{{θ}_{s}} ( y \vert x ) ) \qquad ( 2 )$$

In Equation 2, θ_{T} represents parameters of the teacher encoder 216, θ_{S} represents parameters of the student encoder 212. Thus, assuming the parameters of the teacher encoder 216 are independent of the parameters of the student encoder 212, a gradient of the parameters of the student encoder 212 may be represented by:

$${∇}_{{θ}_{s}} L o s {s}_{C E} ( x ) = {\sum }_{∀ y} {P}_{{θ}_{T}} ( y \vert x ) \times {∇}_{{θ}_{s}} [ - ln ( {P}_{{θ}_{s}} ( y \vert x ) ) ] \qquad ( 3 )$$

Accordingly, the gradient of the parameters of the student encoder 212 with sampling approximation may be represented by:

$${∇}_{{θ}_{s}} L o s {s}_{C E} ( x ) \approx \frac{1}{M} \times {\sum }_{y ∼ {P}_{{θ}_{T}}} {∇}_{{θ}_{s}} [ - ln ( {P}_{{θ}_{s}} ( y \vert x ) ) ] \qquad ( 4 )$$

The unsupervised part 302 updates parameters of the sequence transduction model 200 based on the negative log likelihood loss term 365 determined at each of the plurality of output steps for each unlabeled input sample 303. In some implementations, the unsupervised part 302 is configured to update the parameters of the sequence transduction model 200 based on the negative log likelihood loss term 365 independently of the supervised part 301 updating the parameters of the sequence transduction model 200. In other implementations, the unsupervised part 302 is configured to update the parameters of the sequence transduction model 200 based on the negative log likelihood loss term 365 jointly with the supervised part 301 updating the parameters of the sequence transduction model 200. Updating parameters of the sequence transduction model 200 may include updating parameters of the student encoder 212 of the unsupervised part 302.

In some implementations, parameters of the teacher encoder 216 remain fixed (i.e., are not updated) during the supervised part 301 and/or the unsupervised part 302. In these implementations, however, the quality of the pseudo output labels 334 remain the same because parameters of the teacher encoder 216 are not updated. Thus, in other implementations, the unsupervised part 302 is configured to update parameters of the teacher encoder 216 based on an exponential moving average (EMA) of updated parameters of the student encoder 212. Here, the student encoder 212 and the teacher encoder 216 are initialized using same parameter weights before the self-training network 300 begins training the student encoder 212. Thereafter, the self-training network 300 updates parameters of the student encoder 212 based on the supervised losses 355 and the unsupervised losses (i.e., negative log likelihood loss term) 365 and, thereafter, updates parameters of the teacher encoder 216 based on the EMA of the updated parameters of the student encoder 212. As such, updating parameters of the teacher encoder 216 may be represented by:

θ_{T}^{new}=θ_{T}*(1−∈)+θ_{S}^{new}*∈ (5)

In Equation 5, θ_{T} represents the current parameters of the teacher encoder 216 used to generate pseudo output labels 334, θ_{S}^{new} represents updated parameters of the student encoder 212 updated based on the pseudo output labels 334 generated by the teacher encoder 216 using the θ_{T} parameters, and θ_{T}^{new} represents updated parameters of the teacher encoder 216 based on the EMA of the θ_{S}^{new} parameters. That is, the self-training network 300 does not update the parameters of the teacher encoder 216 by training the teacher encoder 216, but rather updates parameters of the teacher encoder based on the EMA of the updated parameters of the student encoder 212.

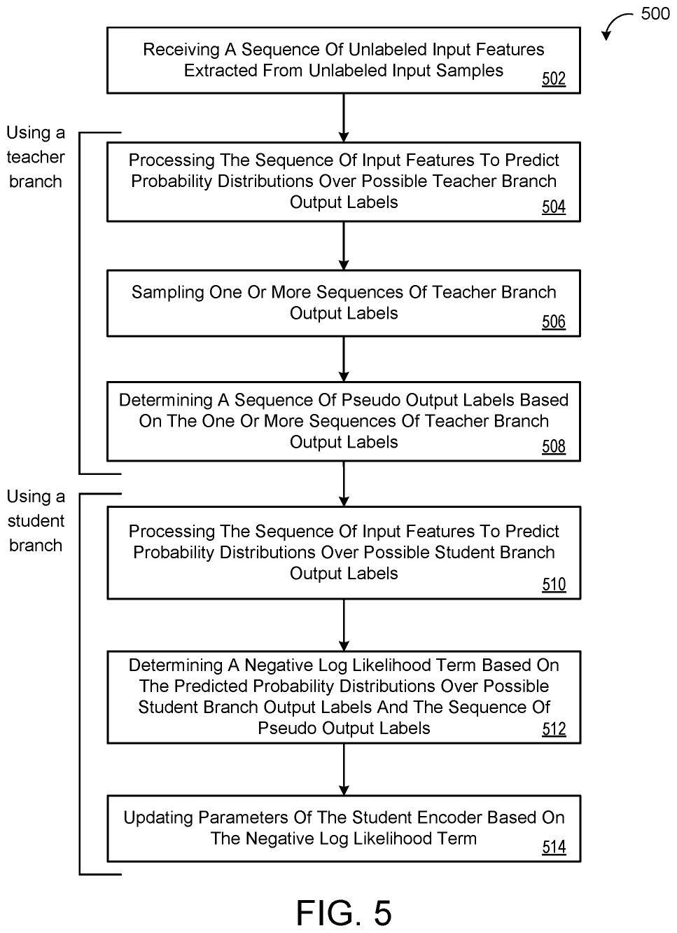

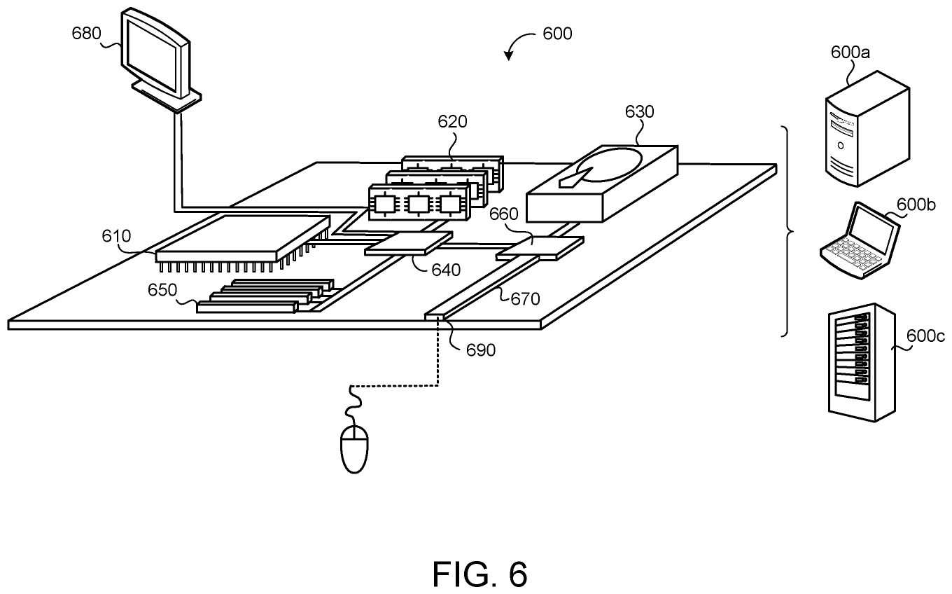

FIG. 5 is a flowchart of an example arrangement of operations for a computer-implemented method 500 for a self-training network for training a sequence transduction model 200. The method 500 may execute on data processing hardware 610 (FIG. 6) using instructions stored on memory hardware 620 (FIG. 6). The data processing hardware 610 and the memory hardware 620 may reside on the user device 102 and/or the remote computing device 201 each corresponding to a computing device 600 (FIG. 6).

At operations 502, the method 500 includes receiving, as input to a self-training network 300 that includes an unsupervised subnetwork 302 trained on a plurality of unlabeled input samples 303, a sequence of unlabeled input features 304 extracted from unlabeled input samples 303. The method 500 performs operations 504-508 using a teacher branch 310 having a teacher encoder 216 of the unsupervised subnetwork 302. At operation 504, the method 500 includes processing the sequence of unlabeled input features 304 to predict probability distributions over possible teacher branch output labels 234. At operation 506, the method 500 includes sampling one or more sequences of teacher branch output labels 332 from the predicted probability distributions over possible teacher branch output labels 234. At operation 508, the method 500 includes determining a sequence of pseudo output labels 334 based on the one or more sequences of teacher branch output labels 332 sampled from the predicted probability distributions over possible teacher branch output labels 234.

The method 500 performs operations 510-514 using a student branch 320 that includes a student encoder 212 of the unsupervised subnetwork 302. At operation 510, the method 500 includes processing the sequence of unlabeled input features 304 extracted from the unlabeled input samples 303 to predict probability distributions over possible student branch output labels 236. At operation 512, the method 500 includes determining a negative log likelihood loss term 365 based on the predicted probability distributions over possible student branch output labels 236 and the sequence of pseudo output labels 334. At operation 514, the method 500 includes updating parameters of the student encoder 212 based on the negative log likelihood loss term 365.

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A self-training network for training a sequence transduction model, the self-training network comprising an unsupervised subnetwork trained on a plurality of unlabeled input samples, the unsupervised subnetwork comprising:
a teacher branch comprising a teacher encoder, the teacher branch configured to:
process a sequence of unlabeled input features extracted from the unlabeled input samples to predict probability distributions over possible teacher branch output labels;
sample, from the predicted probability distributions over possible teacher branch output labels, one or more sequences of teacher branch output labels; and
determine a sequence of pseudo output labels based on the one or more sequences of teacher branch output labels sampled from the predicted probability distributions over possible teacher branch output labels; and
a student branch comprising a student encoder, the student branch configured to:
process the sequence of unlabeled input features extracted from the unlabeled input samples to predict probability distributions over possible student branch output labels;
determine a negative log likelihood term based on the predicted probability distributions over possible student branch output labels and the sequence of pseudo output labels; and
update parameters of the student encoder based on the negative log likelihood term.

2. The self-training network of claim 1, wherein determining the negative log likelihood term comprises determining a negative log of the probability distributions predicted by the student branch for the sequence of pseudo output labels conditioned on the sequence of unlabeled input features.

3. The self-training network of claim 1, wherein:
each teacher branch output label in each sequence of teacher branch output labels comprises a corresponding probability score; and
the teacher branch determines the sequence of pseudo output labels by:
for each corresponding sequence of teacher branch output labels, determining a combined score based on a sum of the probability scores for the corresponding teacher branch output labels; and
selecting the sequence of pseudo output labels as the sequence of teacher branch output labels having the highest combined score.

4. The self-training network of claim 1, wherein the unsupervised subnetwork is configured to update parameters of the teacher encoder based on an exponential moving average (EMA) of updated parameters of the student encoder.

5. The self-training network of claim 4, wherein the student encoder and the teacher encoder are initialized using same parameter weights.

6. The self-training network of claim 1, wherein augmentation is applied to the sequence of unlabeled input features processed by the student branch of the unsupervised subnetwork.

7. The self-training network of claim 6, wherein the augmentation applied comprises at least one of frequency-based augmentation or time-based augmentation.

8. The self-training network of claim 6, wherein no augmentation is applied to the sequence of unlabeled input features processed by the teacher branch of the unsupervised subnetwork.

9. The self-training network of claim 1, wherein the student encoder comprises an encoder neural network having a stack of multi-head attention layers.

10. The self-training network of claim 9, wherein the multi-head attention layers comprise transformer layers or conformer layers.

11. The self-training network of claim 1, further comprising a supervised subnetwork trained on a sequence of labeled input features paired with a corresponding sequence of ground-truth output labels, the supervised subnetwork comprising the student encoder and configured to:
process the sequence of labeled input features to predict probability distributions over possible output labels;
determine a supervised loss term based on the probability distributions over possible output labels and the sequence of ground-truth output labels; and
update parameters of the student encoder based on the supervised loss term.

12. The self-training network of claim 11, wherein:
the sequence of labeled input features comprises a sequence of labeled acoustic frames characterizing a spoken utterance;
the sequence of ground-truth output labels comprises a sequence of word or sub-word units characterizing a transcription of the spoken utterance; and
the probability distributions over possible output labels comprise a probability distribution over possible speech recognition results.

13. The self-training network of claim 1, wherein:
the unlabeled input samples comprise unlabeled audio samples corresponding to spoken utterances not paired with corresponding transcriptions;
the sequence of unlabeled input features comprises a sequence of input acoustic frames extracted from the unlabeled audio samples;
the probability distributions over possible teacher branch output labels comprises probability distributions over possible word or sub-word units;
the probability distributions over possible student branch output labels comprises probability distributions over possible word or sub-word units; and
the sequence of pseudo output labels comprises a sequence of pseudo word or sub-word units.

14. The self-training network of claim 1, wherein the sequence transduction model comprises at least one of a speech recognition model, a character recognition model, or a machine translation model.

15. The self-training network of claim 1, wherein the sequence transduction model comprises a recurrent neural network-transducer (RNN-T) based Transformer-Transducer (T-T) architecture comprising:
the student encoder configured to:
receive, as input, a sequence of acoustic frames extracted from audio data characterizing a spoken utterance; and
generate, at each of a plurality of output steps, a higher order feature representation for a corresponding acoustic frame in the sequence of acoustic frames;
a label encoder configured to:
receive, as input, a sequence of non-blank symbols output by a final softmax layer; and
generate, at each of the plurality of output steps, a dense representation; and
a joint network configured to:
receive, as input, the higher order feature representation generated by the student encoder at each of the plurality of output steps and the dense representation generated by the label encoder at each of the plurality of output steps; and
generate, at each of the plurality of output steps, a probability distribution over possible speech recognition hypotheses at the corresponding output step.

16. A computer-implemented method that when executed on data processing hardware causes the data processing hardware to perform operations for training a sequence transduction model, the operations comprising:
receiving, as input to a self-training network comprising an unsupervised subnetwork trained on a plurality of unlabeled input samples, a sequence of unlabeled input features extracted from the unlabeled input samples;
using a teacher branch comprising a teacher encoder of the unsupervised subnetwork:
processing the sequence of unlabeled input features to predict probability distributions over possible teacher branch output labels;
sampling, from the predicted probability distributions over possible teacher branch output labels, one or more sequences of teacher branch output labels; and
determining a sequence of pseudo output labels based on the one or more sequences of teacher branch output labels sampled from the predicted probability distributions over possible teacher branch output labels; and
using a student branch comprising a student encoder of the unsupervised subnetwork:
processing the sequence of unlabeled input features extracted from the unlabeled input samples to predict probability distributions over possible student branch output labels;
determining a negative log likelihood term based on the predicted probability distributions over possible student branch output labels and the sequence of pseudo output labels; and
updating parameters of the student encoder based on the negative log likelihood term.

17. The computer-implemented method of claim 16, wherein determining the negative log likelihood term comprises determining a negative log of the probability distributions predicted by the student branch for the sequence of pseudo output labels conditioned on the sequence of unlabeled input features.

18. The computer-implemented method of claim 16, wherein:
each teacher branch output label in each sequence of teacher branch output labels comprises a corresponding probability score; and
the teacher branch determines the sequence of pseudo output labels by:
for each corresponding sequence of teacher branch output labels, determining a combined score based on a sum of the probability scores for the corresponding teacher branch output labels; and
selecting the sequence of pseudo output labels as the sequence of teacher branch output labels having the highest combined score.

19. The computer-implemented method of claim 16, wherein the operations further comprise updating, using the unsupervised subnetwork, parameters of the teacher encoder based on an exponential moving average (EMA) of updated parameters of the student encoder.

20. The computer-implemented method of claim 19, wherein the operations further comprise initializing the student encoder and the teacher encoder using same parameter weights.

21. The computer-implemented method of claim 16, wherein the operations further comprise augmenting the sequence of unlabeled input features processed by the student branch of the unsupervised subnetwork.

22. The computer-implemented method of claim 21, wherein augmenting the sequence of input features processed by the student branch of the unsupervised subnetwork comprises at least one of frequency-based augmentation or time-based augmentation.

23. The computer-implemented method of claim 21, wherein no augmentation is applied to the sequence of unlabeled input features processed by the teacher branch of the unsupervised subnetwork.

24. The computer-implemented method of claim 16, wherein the student encoder comprises an encoder neural network having a stack of multi-head attention layers.

25. The computer-implemented method of claim 24, wherein the multi-head attention layers comprise transformer layers or conformer layers.

26. The computer-implemented method of claim 16, wherein:
the self-training network further comprises a supervised subnetwork trained on a sequence of labeled input features paired with a corresponding sequence of ground-truth output labels, the supervised subnetwork comprising the student encoder; and
using the supervised subnetwork, the operations further comprise:
processing the sequence of labeled input features to predict probability distributions over possible output labels;
determining a supervised loss term based on the probability distributions over possible output labels and the sequence of ground-truth output labels; and
updating parameters of the student encoder based on the supervised loss term.

27. The computer-implemented method of claim 26, wherein:
the sequence of labeled input features comprises a sequence of labeled acoustic frames characterizing a spoken utterance;
the sequence of ground-truth output labels comprises a sequence of word or sub-word units characterizing a transcription of the spoken utterance; and
the probability distributions over possible output labels comprise a probability distribution over possible speech recognition results.

28. The computer-implemented method of claim 16, wherein:
the unlabeled input samples comprise unlabeled audio samples corresponding to spoken utterances not paired with corresponding transcriptions;
the sequence of unlabeled input features comprises a sequence of input acoustic frames extracted from the unlabeled audio samples;
the probability distributions over possible teacher branch output labels comprises probability distributions over possible word or sub-word units;
the probability distributions over possible student branch output labels comprises probability distributions over possible word or sub-word units; and
the sequence of pseudo output labels comprises a sequence of pseudo word or sub-word units.

29. The computer-implemented method of claim 16, wherein the sequence transduction model comprises at least one of a speech recognition model, a character recognition model, or a machine translation model.

30. The computer-implemented method of claim 16, wherein:
the sequence transduction model comprises a recurrent neural network-transducer (RNN-T) based Transformer-Transducer (T-T) architecture; and
the operations further comprise:
generating, using the student encoder, at each of a plurality of output steps, a higher order feature representation for a corresponding acoustic frame in a sequence of acoustic frames extracted from audio data characterizing a spoken utterance;
generating, using a label encoder, at each of the plurality of output steps, a dense representation based on a sequence of non-blank symbols output by a final softmax layer; and
generating, using a joint network, at each of the plurality of output steps, a probability distribution over possible speech recognition hypotheses at the corresponding output step based on the higher order feature representation generated by the student encoder at each of the plurality of output steps and the dense representation generated by the label encoder at each of the plurality of output steps.
